(19) United States
(12) Patent Application Publication
(10) Pub. No.: US 2002/0154143 A1
(43) Pub. Date: Oct. 24, 2002

(54) Method of using wood to render images onto surfaces

(76) Inventor: Christopher Maier, New Orleans, LA (US)

Correspondence Address: MICHAEL D CARBO, PLC, 700 WHITNEY BANK BUILDING, 228 ST CHARLES AVENUE, NEW ORLEANS, LA, 70130, US

(21) Appl. No.: 09/827,460

(22) Filed: Apr. 6, 2001

(51) Int. Cl. G06K 9/36; G06K 9/32; G09G 5/00

(52) U.S. Cl. 345/634; 382/284; 382/294

(57) ABSTRACT

A method for rendering and applying images onto furniture surfaces and other surfaces capable of accepting veneers whereby a photograph, picture, or other image is transformed by computer software into a grid indicating the placement of veneer pieces of varying tones, preferably pieces made from wood of varying tones, and then the pieces are applied to the grid, creating an image on the surface. Digital data corresponding to the image are generated by scanning or another method. Image editing computer software is used to generate from the data a template having grid cells containing a plurality of tones corresponding to the weighted value of tones in the corresponding area of the image. A mosaic image is created by covering the template with pieces of material having a range of tones corresponding to the plurality of tones contained in the grid cells. The covered side of the material-covered template is adhered or laminated to a surface of an object, and the template is removed from the adhered or laminated materials. Alternatively, the template is then rendered onto the surface, and the mosaic image is created by covering the template with pieces of veneer having a range of tones corresponding to the plurality of tones contained in the grid cells.

### CROSS REFERENCE TO RELATED APPLICATIONS

Not Applicable.

### COPYRIGHT STATEMENT

Not applicable.

### FEDERAL RESEARCH STATEMENT

Not applicable.

### BACKGROUND OF INVENTION

1. Field of Invention.

The invention relates to a method for rendering and applying images onto surfaces, and particularly to a method for rendering and applying mosaic portrait images onto furniture and other surfaces capable of accepting veneers.

2. Description of Related Art.

Conventionally, images can be rendered or applied onto furniture by drawing or painting on a surface thereof, or by overlaying or applying to such surface another material containing an image. Mosaic images have been expressed in art for centuries. Artists have arranged colored tiles to form mosaic images in constructed surfaces such as fountains, patios, and walls. Recently, Lego Corporation has advertised a process for turning any scanned photograph or picture into a poster-sized mosaic made entirely from LEGO brand bricks. Lego Corporation uses software for editing digital images to provide a mounting panel, used as a template, to which black, gray scale, and white bricks are applied to produce a wall hanging bearing an image of the scanned photograph or picture.

Available digital image editing tools, such as Adobe Photoshop, can be used to create a grid pattern having grid cells rendered in black, gray scale, and white to form a mosaic image conforming to an image that has been digitally scanned. Digital image editing tools can be used to edit a scanned image before rendering the gridded, gray scaled image. Particular colors or gray scale tones, or particular numbers, letters, or other marks or images, can be placed in the grid cells to act as a template.

There remains a need for conveniently rendering a mosaic image onto a surface of furniture, decorative panels, millwork, and other freestanding and installed furniture.

### SUMMARY OF THE INVENTION

The present invention provides an improved method for rendering a mosaic image onto any surface onto which wood or other veneers can be applied. According to the present invention, a photograph, picture, or other image is scanned to create digital data that can be manipulated by conventional image editing software, using the software to create a gridded image having grid cells, preferably square, the grid cells containing black, gray scale, and white tones corresponding to a weighted value of the tones in corresponding sections of the original image. The gridded image is printed onto paper or another flat material, which is then adhered or otherwise affixed to a surface to be veneered. Alternatively, a gridded image can be applied or rendered directly onto the surface of a surface to be veneered by inscribing the surface in a grid pattern and marking the interior of the grid cells with tonal value identifiers. Finally, individual veneer pieces, corresponding in shape to the grid cells and corresponding in tone to the tones within the grid cells, are applied using conventional furniture and other finishing techniques. The individual veneer pieces are selected from a range of woods having different tones. Preferably, maple, birdseye maple, eucalyptus, pear, cherry, walnut, French walnut, and ebony are selected because these eight woods are available as veneers and can create a range of wood color tones that can render a mosaic image of facial portraits that are recognizable as the person whose image is used.

### BRIEF DESCRIPTION OF THE DRAWING

The method of the present invention should become apparent from the following description when considered with the accompanying drawing, in which:

FIG. 1 depicts in perspective view a table veneered in accordance with the present invention;

FIG. 2 depicts a printed grid cell image produced by digital editing software for use in practicing the present invention; and

FIG. 3 depicts in top view a table veneered in accordance with the present invention, showing a mosaic facial image; and

FIG. 4 depicts a side view of a table veneered in accordance with the present invention.

### DETAILED DESCRIPTION OF THE INVENTION:

Referring more specifically to the several views of the drawing, FIG. 1 depicts table 1 having top surface 2. Top surface 2 contains wood veneer strips that have been applied to top surface 2 to render an image thereon.

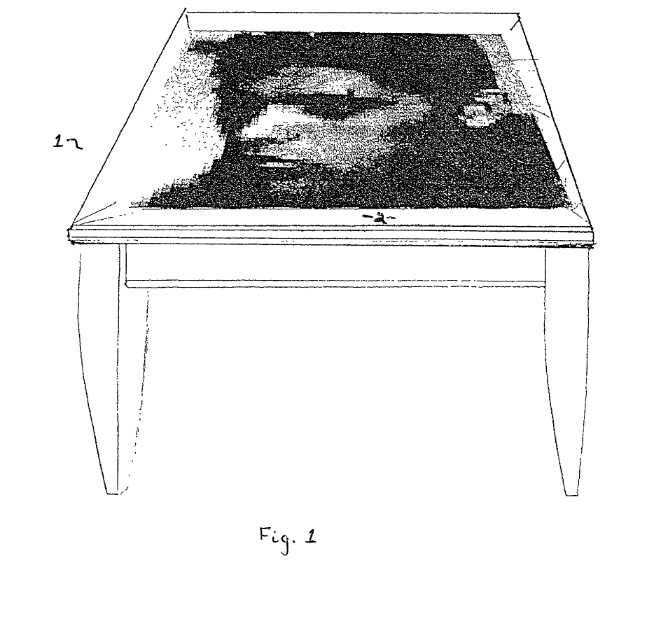

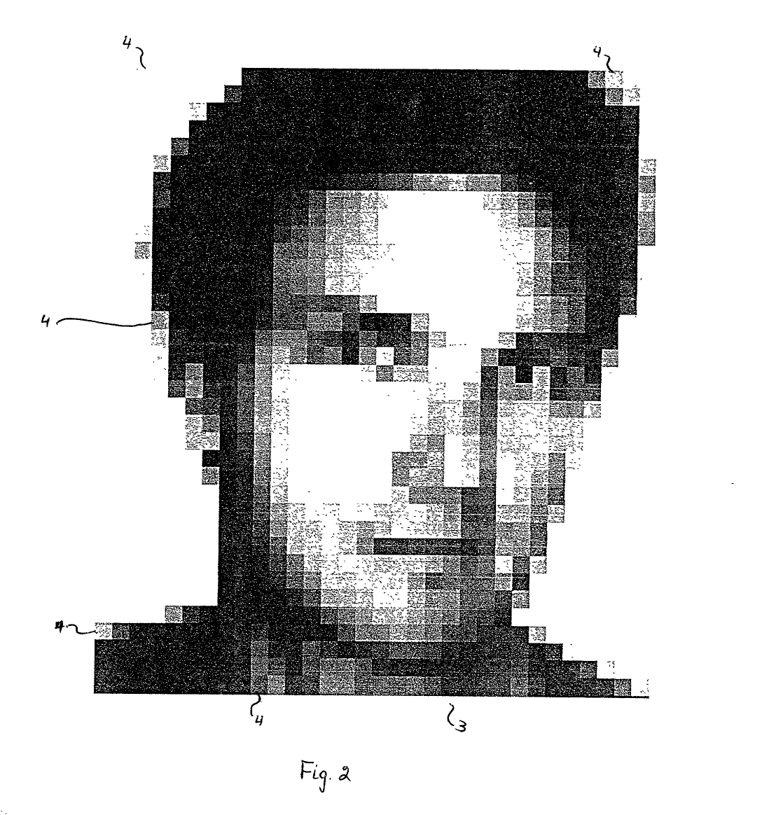

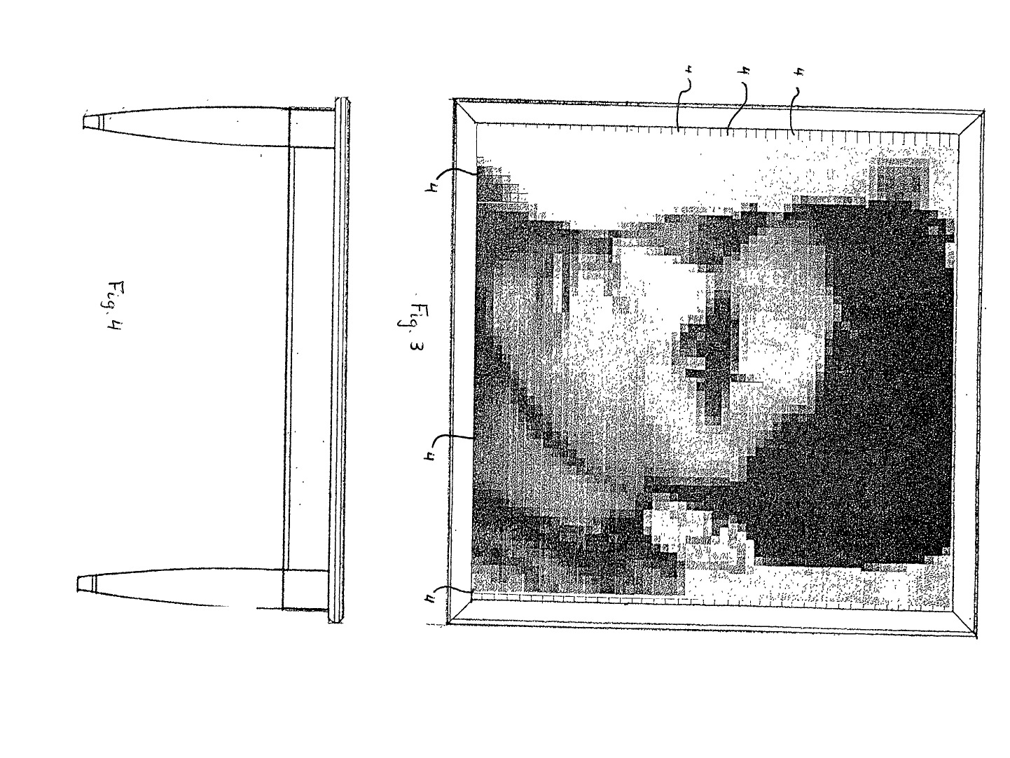

Referring to FIG. 2, printed image template 3 contains a multiplicity of grid cells 4. The shape of each grid cell 4 is preferably square, but can alternatively be rectangular or any other shape or shapes that can be arranged contiguously to fill a plane or otherwise to create a desired overall shape. The tone or color of adjacent grid cells can vary over a range. Preferably, eight discrete tonal values are selected to allow eight different woods or wood veneers, having shades that vary from maple at the light end of the range to ebony at the dark end of the range, to be applied to a surface to render a mosaic image. Alternatively, more or fewer discrete tonal values can be used, but with fewer tonal values, the resulting image cannot be resolved or focused on as well at conventional viewing distances. With the use of substantially more than eight tonal values, the image can take substantially more time to construct if people are assembling a mosaic image by selecting veneer pieces from compartments or bins, each compartment or bin containing a supply of single-tone veneer strips.

Preferably, a 32 by 32 cell grid pattern is used as a template for placement of the individual veneer strips, and eight different wood tones are applied to the template, which template is either inscribed on or otherwise applied or affixed to a surface on which a mosaic image is to be rendered.

The dimensions of the grid cells are selected to allow a viewer to resolve a recognizable image when focusing on the entire mosaic.

While particular embodiments made according to the present invention have been illustrated and described herein, the present invention should not be limited to such illustrations and descriptions. It should be apparent that changes and modifications may be incorporated and embodied as part of the present invention within the scope of the following claims.

I claim:

1. A method of rendering a mosaic image onto a surface of an object, the method comprising the acts of:
(a) generating digital data corresponding to a first image, the digital data being capable of being used and manipulated by image editing computer software;
(b) creating a template having grid cells containing a plurality of tones corresponding to a weighted value of tones contained in corresponding areas of the first image;
(c) rendering the template onto the surface of the object; and
(d) creating a mosaic image by covering the template with pieces of material, the pieces of material having a range of tones corresponding to the plurality of tones contained in the grid cells.

2. The method according to claim 1, whereby the first image is a photographic portrait and the generating act comprises scanning the photographic portrait.

3. The method according to claim 1, whereby the developing act comprises using digital image editing software to manipulate the digital data to create the template.

4. The method according to claim 3, whereby the template is printed onto a sheet of material.

5. The method according to claim 4, whereby the template is affixed to the surface of the object onto which the mosaic image is created.

6. The method according to claim 3, whereby the template is inscribed onto the surface of the object.

7. The method according to claim 1, whereby the pieces of material comprise veneer woods.

8. The method according to claim 7, whereby the veneer woods are selected from the group consisting of maple, birdseye maple, eucalyptus, pear, cherry, walnut, French walnut, and ebony.

9. The method according to claim 1, whereby the size of each grid cell, the number of grid cells, and the number of tones are selected so that the mosaic image is recognizable to a viewer as corresponding to the first image.

10. A method of creating a mosaic image on a surface of an object, the method comprising the acts of:
(a) generating digital data corresponding to a first image, the digital data being capable of being used and manipulated by image editing computer software;
(b) creating a template having grid cells containing a plurality of tones corresponding to a weighted value of tones contained in corresponding areas of the first image;
(c) creating a mosaic image by covering the template with pieces of material, the pieces of material having a range of tones corresponding to the plurality of tones contained in the grid cells.
(d) adhering or laminating the covered side of the material covered template against a surface of the object; and
(e) removing the template from the adhered or laminated materials.
